(19) United States
(12) Patent Application Publication
(10) Pub. No.: US 2016/0335976 A1
(43) Pub. Date: Nov. 17, 2016

(54) LIQUID CRYSTAL DISPLAY

(71) Applicant: SHENZHEN CHINA STAR OPTOELECTRONICS TECHNOLOGY CO., LTD., Shenzhen, Guangdong (CN)

(72) Inventors: Xinhong CHEN, Shenzhen, Guangdong (CN); Yu-yeh CHEN, Shenzhen, Guangdong (CN); Ming-wei CHEN, Shenzhen, Guangdong (CN); Xianming ZHANG, Shenzhen, Guangdong (CN)

(73) Assignee: Shenzhen China Star Optoelectronics Technology Co., Ltd., Shenzhen, Guangdong (CN)

(21) Appl. No.: 14/426,745

(22) PCT Filed: Nov. 17, 2014
(86) PCT No.: PCT/CN2014/091293

§ 371 Date: Mar. 7, 2015

(30) Foreign Application Priority Data
Nov. 7, 2014 (CN) 201410626055.3

(51) Int. Cl. G09G 3/36

(52) U.S. Cl. CPC G09G 3/3696; G09G 2330/021; G09G 2310/08

(57) ABSTRACT

The present invention discloses a liquid crystal display, including: a liquid crystal panel, which defines n first division zones in a first direction; a gate driver, which includes n gate driver chips respectively corresponding to the n first division zones, the gate driver chips each including a control unit and a first electrical resistance unit; a timing controller, which is arranged to supply a control signal to the liquid crystal display; and a common voltage generator, which supplies a common voltage source that is fed in sequence to the n gate driver chips. The control unit receives the control signal from the timing controller and controls the first electrical resistance unit to generate a first matching impedance and the gate driver chip, in response to the common voltage source fed thereto and the first matching impedance, supplies a first common voltages from the first direction to the one of the first division zones so that the n gate driver chips respectively supply n first common voltages to the n first division zones whereby the n first common voltages are made identical through adjustments of the first matching impedances, where n is an integer greater than one.

### BACKGROUND OF THE INVENTION

1. Field of the Invention

The present invention relates to a liquid crystal display.

2. The Related Arts

A liquid crystal display is a flat and ultra-thin display device, which is composed of a predetermined number of color or monochromic pixels to be placed in front of a light source or a reflection surface. The liquid crystal display has an extremely low power consumption and possesses various advantages, such as high image quality, small volume, and light weight, and are thus very favorite by the public, making it the mainstream of display devices. The liquid crystal displays that are currently available are primarily thin-film transistor (TFT) liquid crystal displays.

FIG. 1 is a schematic view showing the structure of a conventional liquid crystal display. As shown in FIG. 1, the liquid crystal display comprises at least a liquid crystal panel 1, a source controller 2, a gate controller 3, a timing controller 4, and a common voltage generator 5, wherein the source controller 2 supplies a data signal to the liquid crystal panel 1; the gate controller 3 supplies a scan signal to the liquid crystal panel 1; and the timing controller 4 supplies a control signal to the liquid crystal display. The liquid crystal panel 1 generally needs a common voltage Vcom and a known way to supply the common voltage Vcom is to arrange a common voltage line along an edge of the liquid crystal panel 1, such as the common voltage line 6 shown in FIG. 1, and the common voltage generator 5 supplies the common voltage Vcom to the common voltage line 6 so that each of pixels contained in the liquid crystal panel 1 can receive the common voltage Vcom by being connected to the common voltage line 6. However, in the above-described way, due to the influence of trace impedance, the longer the trace is, the great the voltage drop will be. The unbalance of the common voltage Vcom at each point inside the liquid crystal panel would affect the displaying quality of the liquid crystal panel, such as inducing image flicker phenomenon. Thus, the common voltage Vcom supplied to each point inside the liquid crystal panel should be kept as consistent as possible.

### SUMMARY OF THE INVENTION

In view of the shortcoming of the prior art, the present invention provides a liquid crystal display and the liquid crystal display allows for input of a common voltage at various different locations of a liquid crystal panel so as to effectively reduce the problem of voltage drop caused by trace impedance and thus ensuring the common voltage of each point of the liquid crystal panel can be maintained as consistent as possible to thereby enhance the displaying quality of the liquid crystal panel.

To achieve the above object, the present invention provides the following technical solution:

A liquid crystal display, which comprises:

a liquid crystal panel, which defines n first division zones in a first direction;

a gate driver, which comprises n gate driver chips, each of the gate driver chips corresponding to one of the first division zones, the gate driver chip comprising at least a control unit and a first electrical resistance unit;

a timing controller, which is arranged to supply a control signal to the liquid crystal display; and

a common voltage generator, which supplies a common voltage source, the common voltage source being fed in sequence to the n gate driver chips;

wherein the control unit receives the control signal from the timing controller and controls the first electrical resistance unit to generate a first matching impedance and the gate driver chip, in response to the common voltage source fed thereto and the first matching impedance, supplies a first common voltages from the first direction to the one of the first division zones; and the n gate driver chips respectively supply n first common voltages to the n first division zones whereby the n first common voltages are made identical through adjustments of the first matching impedances, where n is an integer greater than one.

Wherein, the control signal is supplied from the timing controller to the control units and comprises at least a start signal and an impedance match signal, where the start signal is applicable to sequentially turn on the n gate driver chips and the impedance match signal comprises a square wave signal, each of periods of the impedance match signal corresponding to one of the gate driver chips; and the control unit of each of the gate driver chips determines and generates a value of the matching impedance according to a width of high voltage of the corresponding period of the impedance match signal, wherein a relatively large value of the matching impedance is generated for one of the gate driver chips that is relatively close to an input end of the common voltage source and a relatively small value of the matching impedance is generated for one of the gate driver chips that is relatively distant from the input end of the common voltage source.

Wherein, when a width of high voltage of one of the periods of the impedance match signal is relatively large, the matching impedance generated by the first electrical resistance unit of the one of the gate driver chips corresponding to the period is relatively large.

Wherein, the gate driver chips each further comprises a counter unit and the control signal that the timing controller supplies to the control unit further comprises a clock signal; the counter unit counts the number of periods of the clock signal occurring during a width of high voltage of one of the periods of the impedance match signal and the control unit determines and generates a value of the matching impedance according to the number of the periods counted.

Wherein, when the number of the periods counted is large, the value of the matching impedance generated by the first electrical resistance unit of the gate driver chip is correspondingly large.

Wherein, the number of the periods counted and the value of the matching impedance are of a linear relationship.

Wherein, the liquid crystal panel further defines n second division zones in a second direction; the gate driver chip further comprises a second electrical resistance unit; and wherein the control unit further controls the second electrical resistance unit to generate a second matching impedance according to the control signal and the gate driver chip, in response to the second matching impedance, supplies a second common voltage from the second direction to one of the second division zones; and the n gate driver chips respectively supply n second common voltages to the n second division zones whereby the n second common voltages are made identical through adjustments of the second matching impedances.

Wherein, the first common voltages and the second common voltages are identical to each other.

Wherein, the first direction and the second direction are perpendicular to each other; and the first direction is a short side or long side direction of the liquid crystal panel and the second direction is a long side or short side direction of the liquid crystal panel.

Wherein, the value of n is set to be 4-8.

Wherein the first electrical resistance unit and the second electrical resistance unit each comprise a resistance variable unit.

Compared to the known art, the present invention provides, in one embodiment thereof, a liquid crystal display, wherein a liquid crystal panel defines a plurality of division zones in a short side direction and a plurality of gate driver chips respectively supply common voltages to the plurality of division zones according to a control signal so as to achieve inputting of common voltages at various locations of the liquid crystal panel so as to effectively reduce the problem of voltage drop caused by trace impedance and thus ensuring the common voltage of each point of the liquid crystal panel can be maintained as consistent as possible to thereby enhance the displaying quality of the liquid crystal panel. In another embodiment of the present invention, the liquid crystal panel also defines a plurality of division zones in a long side direction and the plurality of gate driver chips corresponding thereto respectively supply common voltages to the plurality of division zones of the long side direction according to the control signal so as to enhance the consistency of the common voltages of various points of the liquid crystal panel.

### BRIEF DESCRIPTION OF THE DRAWINGS

FIG. 1 is a schematic view showing the structure of a conventional liquid crystal display;

FIG. 2 is a schematic view showing the structure of a liquid crystal display provided according to an embodiment of the present invention;

FIG. 3 is a signal connection diagram between a gate driver and a timing controller provided according to the embodiment of the present invention;

FIG. 4 is a schematic view showing the structure of a gate driver chip provided according to the embodiment of the present invention;

FIG. 5 is a waveform diagram showing control signals received by the gate driver provided according to the embodiment of the present invention;

FIG. 6 is a schematic view showing the structure of a liquid crystal display provided according to another embodiment of the present invention; and

FIG. 7 is a schematic view showing the structure of a gate driver chip provided according to said another embodiment of the present invention.

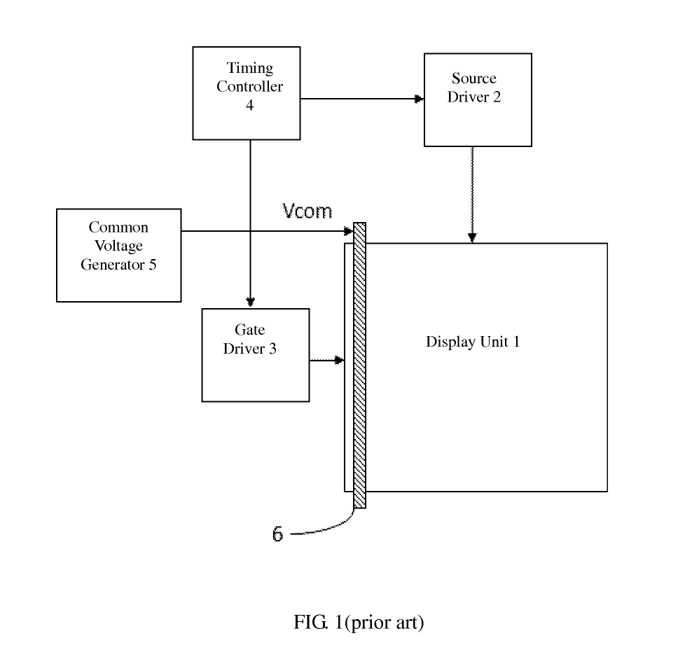

### DETAILED DESCRIPTION OF THE PREFERRED EMBODIMENTS

As stated previously, the object of the present invention is to provide a liquid crystal display and the liquid crystal display allows for input of a common voltage at various different locations of a liquid crystal panel so as to effectively reduce the problem of voltage drop caused by wiring resistance and thus ensuring the common voltage of each point of the liquid crystal panel can be maintained as consistent as possible to thereby enhance the displaying quality of the liquid crystal panel.

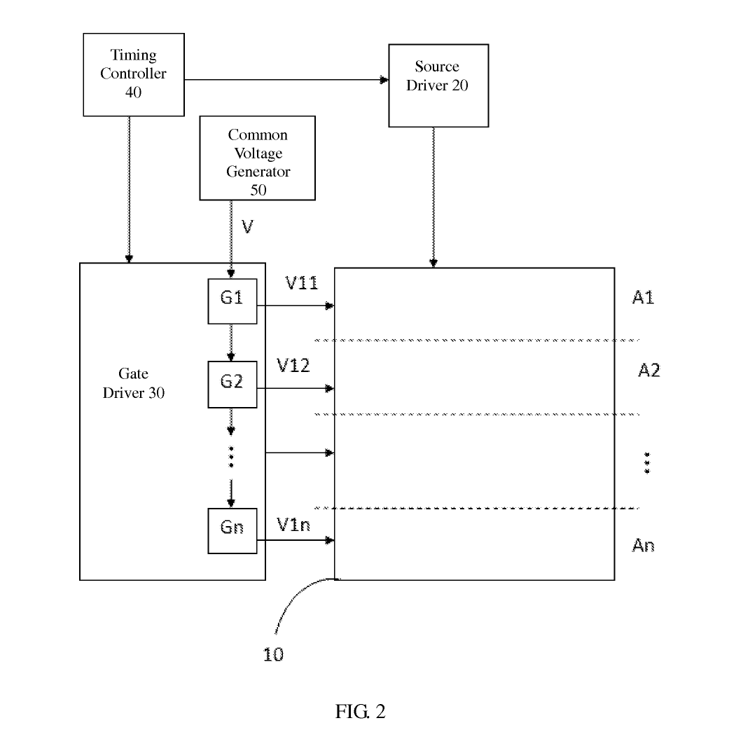

FIG. 2 is a schematic view of the structure of a liquid crystal display provided by the present invention.

Referring to FIG. 2, a liquid crystal display that is disclosed according to the present invention comprises a liquid crystal panel 10, a source driver 20, a gate driver 30, a timing controller 40, and a common voltage generator 50, wherein the source controller 20 supplies a data signal to the liquid crystal panel 10; the gate controller 30 supplies a scan signal to the liquid crystal panel 10; the timing controller 40 supplies a control signal to the liquid crystal display; and the common voltage generator 50 supplies a common voltage source.

As shown in FIG. 2, the liquid crystal panel 10 defines, in a short side direction, n first division zones A1, A2, . . . , An (in another embodiment, the first division zones A1, A2, . . . , An being formed through division made in a long side direction of the liquid crystal panel 10). Correspondingly, the gate driver 30 comprises n gate driver chips G1, G2, . . . , Gn and each of the gate driver chips Gi corresponds to one of the first division zones Ai. The common voltage source V supplied by the common voltage generator 50 is fed sequentially to the n gate driver chips G1, G2, . . . , Gn. In other words, the n gate driver chips G1, G2, . . . , Gn are connected in series along a transmission line of the common voltage source V and the n gate driver chips G1, G2, . . . , Gn, in response to the common voltage source V received, generate n first common voltages V11, V12, . . . , V1n that are each supplied from the short side direction to the n first division zones A1, A2, . . . , An so as to achieve the purposes of inputting the common voltage from various locations of the liquid crystal panel. In the above, n is an integer greater than 1 and m=1, 2, . . . , n.

Due to the influence of the trace impedance, the common voltage source V, when fed to the gate driver chips G1, G2, . . . , Gn, may induce different voltage drops. To keep the first common voltages V11, V12, . . . , V1n generated by the gate driver chips G1, G2, . . . , Gn identical, an improvement is made on the structure of the gate driver chips G1, G2, . . . , Gn. The generation of the first common voltages V11, V12, . . . , V1n by the gate driver chips G1, G2, . . . , Gn will be described as follows. In the following embodiment, an example that the gate driver 30 comprises four (4) gate driver chips G1, G2, G3, G4 is taken for illustration purposes. In other words, the value of n is set to 4; however, in other embodiments, a preferred range of the value of n may be 4-8.

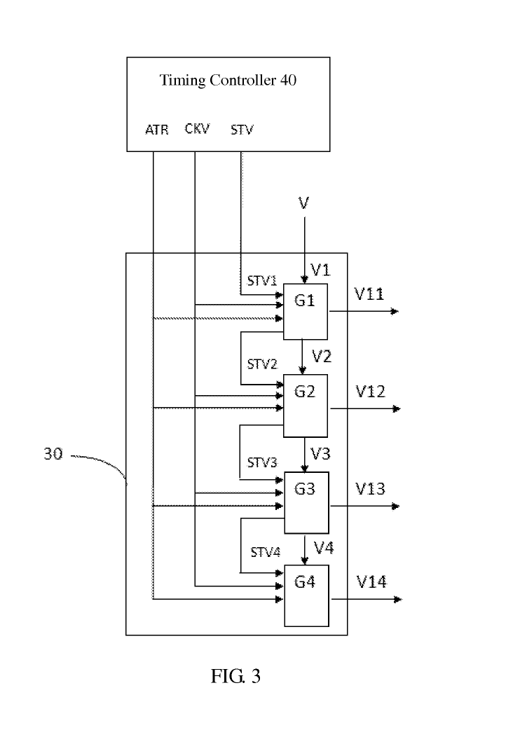

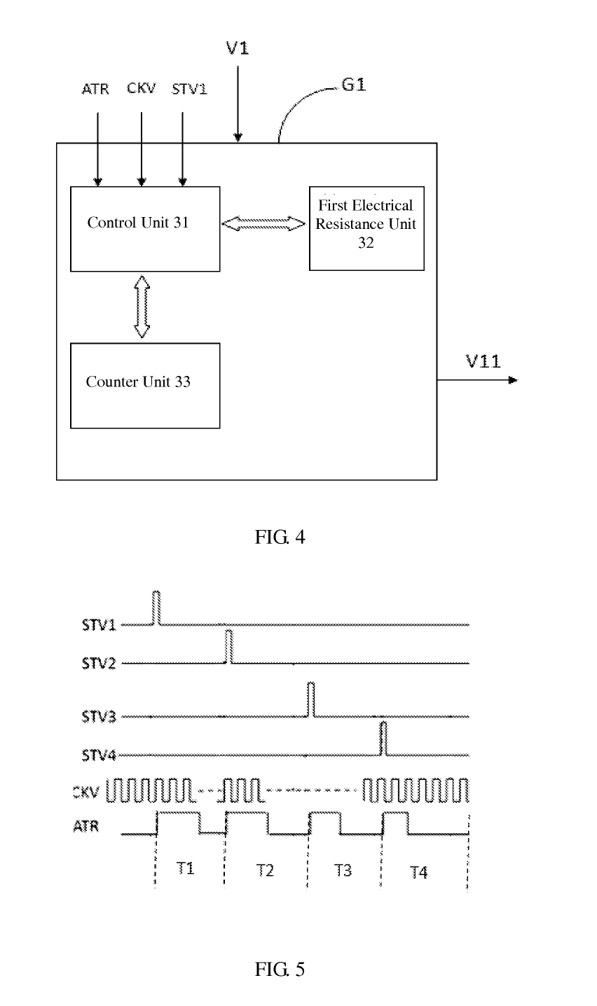

FIG. 3 is a signal connection diagram between the gate driver 30 and the timing controller 40 and FIG. 4 is a schematic view showing the structure of the gate driver chips (where the gate driver chip G1 is taken as an example for the illustration of FIG. 4). Referring to FIGS. 3 and 4, the gate driver chip G1 comprises at least a control unit 31 and a first electrical resistance unit 32. The control signal supplied from the timing controller 40 to the control unit 31 of the gate driver 30 comprises at least start signals STV and an impedance match signal ATR. The start signals STV (as shown in FIG. 3, including STV1, STV2, STV3, and STV4) are provided to sequentially turn on the four gate driver chips G1, G2, G3, G4. Voltages fed from the common voltage source V to the gate driver chips G1, G2, G3, G4 are respectively V1, V2, V3, V4 and due to the influence of the trace impedance, V1>V2>V3>V4. The impedance match signal ATR includes a square wave signal. In a frame of image, each period of the impedance match signal ATR corresponds to one of the gate driver chips G1, G2, G3, G4. Based on the width of high voltage level of corresponding period of the impedance match signal ATR, the control unit 31 of each of the gate driver chips G1, G2, G3, G4 controls the first electrical resistance unit 32 to determine and generate a value of a matching impedance and the first electrical resistance unit 32 feeds the matching impedance so generated back to the control unit 31 to allow the control unit 31 to control the gate driver chip G1, G2, G3, G4 to generate a corresponding common voltage V11, V12, V13, V14, wherein when width of the high voltage of one specific period of the impedance match signal ATR is greater, the matching impedance generated by the first electrical resistance unit 31 of the gate driver chip G1, G2, G3, G4 corresponding to the specific period is larger and this is equivalent to achieving matching with the trace impedance of the common voltage source V so that a gate driver chip that is close to an input end of the common voltage source V is provided with a large matching impedance, while a gate driver chip that is distant from the input end of the common voltage source V is provided with a small matching impedance whereby the common voltages V11, V12, V13, V14 generated by the corresponding gate driver chips G1, G2, G3, G4 can be made identical.

As shown in FIGS. 3 and 4, as a preferred embodiment, the gate driver chips G1, G2, G3, G4 may further comprise a counter unit 33 and the control signal that the timing controller 40 supplied to the control unit 31 further comprises a clock signal CKV. Within the width of high voltage of a period of the impedance match signal ATR, the counter unit 33 counts and feeds the number of the periods of the clock signal CKV to the control unit 31, so that the control unit 31 may determine the value of the matching impedance to be generated by the first electrical resistance unit 32 according to the number of the periods so counted. The waveforms of the start signal STV (which includes STV1, STV2, STV3, and STV4), the impedance match signal ATR, and the clock signal CKV in a frame of image are illustrated in FIG. 5. In FIG. 5, the impedance match signal ATR has a period T1 corresponding to the gate driver chips G1, a period T2 corresponding to the gate driver chips G2, a period T3 corresponding to the gate driver chips G3, and a period T4 corresponding to the gate driver chips G4, wherein when the number of the periods of the clock signal CKV counted in the width of high voltage of one period of the impedance match signal ATR is larger, the matching impedance generated by the first electrical resistance unit 32 of the corresponding one of the gate driver chips G1, G2, G3, G4 is larger. The relationship between the number of the periods counted and the matching impedance can be set as a linear relationship.

In the liquid crystal display provided in the above embodiment, the liquid crystal panel is arranged to define a plurality of division zones in the short side direction and a plurality of gate driver chips is arranged to supply common voltages of the same voltage value to the plurality of division zones according to a control signal fed thereto so as to achieve inputting of the common voltages at various locations of a liquid crystal panel to effectively reduce the voltage drop issue of the common voltages caused by the trace impedance, make the common voltage supplied to each point within the liquid crystal panel kept as consistent as possible to each other, and enhance displaying quality of the liquid crystal panel.

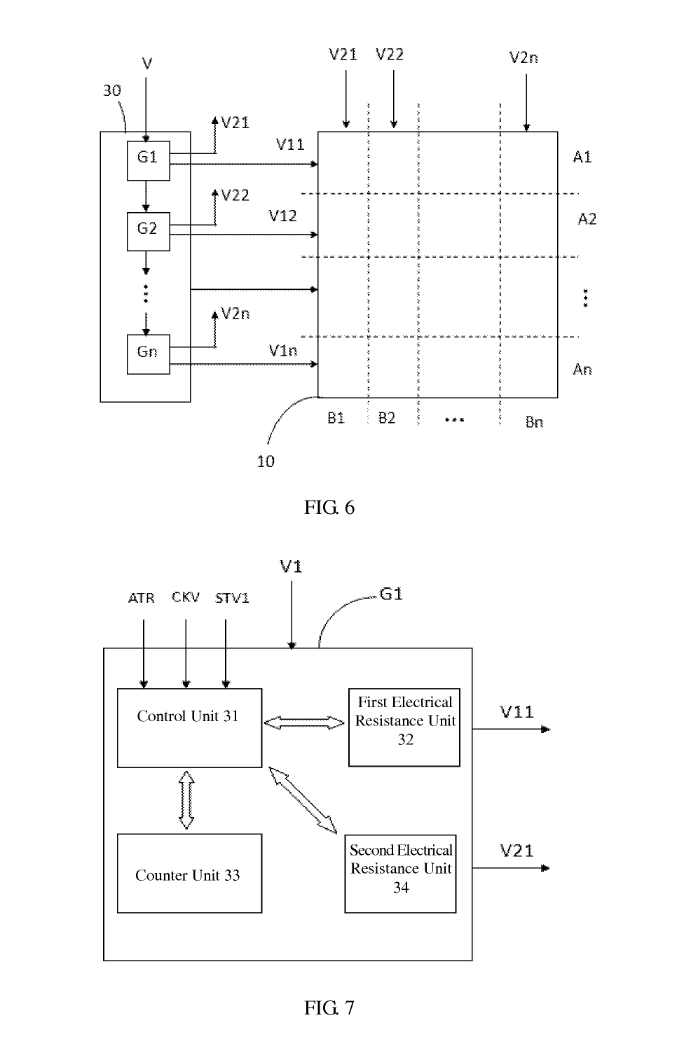

In another preferred embodiment, as schematically shown in the structure of FIG. 6, besides defining the n first division zones A1, A2, . . . , An in the short side direction, the liquid crystal panel 10 also defines n second division zones B1, B2, . . . , Bn in a long side direction thereof. For the n gate driver chips G1, G2, . . . , Gn of the gate driver 30, each gate driver chips Gi corresponds to one of the first division zones Ai and one of the second division zones Bi. The common voltage source V is sequentially fed to the n gate driver chips G1, G2, . . . , Gn. In other words, the n gate driver chips G1, G2, . . . , Gn are connected in series along a transmission line of the common voltage source V and the n gate driver chips G1, G2, . . . , Gn, in response to the common voltage source V received, generate n first common voltages V11, V12, . . . , V1n that are each supplied from the short side direction to the n first division zones A1, A2, . . . , An and then, the n gate driver chips G1, G2, . . . , Gn, in response to the common voltage source V received, generate n second common voltages V21, V22, . . . , V2n that are each supplied from the long side direction to the n second division zones B1, B2, . . . , Bn, wherein the first common voltages V11, V12, . . . , V1n are of the same voltage value and the second common voltages V21, V22, . . . , V2n are of the same voltage value and the first common voltages V11, V12, . . . , V1n and the second common voltages V21, V22, . . . , V2n are identical, namely V11=V12= . . . =V1n=V21=V22= . . . =V2n.

In the instant embodiment, the structure of the gate driver chips is schematically shown in FIG. 7 (where the gate driver chip G1 is taken as an example for the illustration of FIG. 7) and the gate driver chips G1, G2, . . . , Gn of the instant embodiment further comprises a second electrical resistance unit 34. Similar to the previous embodiment, the control units 31 of the gate driver chips G1, G2, . . . , Gn determine the values of the matching impedances to be generated by the first electrical resistance units 32 according to the numbers of the periods of the clock signals CKV counted by the counter units 33 and control the gate driver chips G1, G2, . . . , Gn to respectively generate the first common voltages V11, V12, . . . , V1n according to the matching impedances. Reference being made to what described in the above, the control units 31 of the gate driver chips G1, G2, . . . , Gn determine the values of matching impedances to be respectively generated by the second electrical resistance units 34 according to the numbers of the periods of the clock signals CKV counted by the counter units 33 and control the gate driver chips G1, G2, . . . , Gn to respectively generate the second common voltages V21, V22, . . . , V2n according to the matching impedances.

In the liquid crystal display provided in the instant embodiment, the liquid crystal panel is further arranged to define a plurality of division zones in the long side direction thereof and a plurality of gate driver chips is arranged to correspond thereto respectively supply common voltages to the plurality of division zones of the long side direction according to the control signal so as to further improved the consistency of the common voltage supplied to each point of the liquid crystal panel.

In the embodiment provided above, the first electrical resistance unit 32 and the second electrical resistance units 34 are preferably resistance variable units.

It is noted here that in the description given herein, terminology, such as first and second, is used to distinguish one object or operation from another object or operation and do not necessarily define or imply any specific relationship or sequence, in such an order, between the objects or operations. Further, the word “comprise”, “include”, or other variations thereof is used in a non-exclusive manner so that a process, a method, an article, or a device that comprises a series of elements may include, besides these elements, other elements that are not explicitly described elements or further include elements that inherent to the process, the method, the article, or the device. Without explicitly stated constraints, the elements that are defined in the phrase “comprising one . . . ” do not exclude additional and identical elements being included in the process, the method, the object, or the device.

Although the present invention has been described with reference to the preferred embodiments thereof, it is noted that those having ordinary skills may appreciate improvements and modifications without departing from the principle of the present invention and those improvements and modifications are considered within the scope of protection of the present invention.

What is claimed is:

1. A liquid crystal display, comprising:
a liquid crystal panel, which defines n first division zones in a first direction;
a gate driver, which comprises n gate driver chips, each of the gate driver chips corresponding to one of the first division zones, the gate driver chip comprising at least a control unit and a first electrical resistance unit;
a timing controller, which is arranged to supply a control signal to the liquid crystal display; and
a common voltage generator, which supplies a common voltage source, the common voltage source being fed in sequence to the n gate driver chips;
wherein the control unit receives the control signal from the timing controller and controls the first electrical resistance unit to generate a first matching impedance and the gate driver chip, in response to the common voltage source fed thereto and the first matching impedance, supplies a first common voltages from the first direction to the one of the first division zones; and the n gate driver chips respectively supply n first common voltages to the n first division zones whereby the n first common voltages are made identical through adjustments of the first matching impedances, where n is an integer greater than one.

2. The liquid crystal display as claimed in claim 1, wherein the control signal is supplied from the timing controller to the control units and comprises at least a start signal and an impedance match signal, where the start signal is applicable to sequentially turn on the n gate driver chips and the impedance match signal comprises a square wave signal, each of periods of the impedance match signal corresponding to one of the gate driver chips; and the control unit of each of the gate driver chips determines and generates a value of the matching impedance according to a width of high voltage of the corresponding period of the impedance match signal, wherein a relatively large value of the matching impedance is generated for one of the gate driver chips that is relatively close to an input end of the common voltage source and a relatively small value of the matching impedance is generated for one of the gate driver chips that is relatively distant from the input end of the common voltage source.

3. The liquid crystal display as claimed in claim 2, wherein when a width of high voltage of one of the periods of the impedance match signal is relatively large, the matching impedance generated by the first electrical resistance unit of the one of the gate driver chips corresponding to the period is relatively large.

4. The liquid crystal display as claimed in claim 2, wherein the gate driver chips each further comprises a counter unit and the control signal that the timing controller supplies to the control unit further comprises a clock signal; the counter unit counts the number of periods of the clock signal occurring during a width of high voltage of one of the periods of the impedance match signal and the control unit determines and generates a value of the matching impedance according to the number of the periods counted.

5. The liquid crystal display as claimed in claim 4, wherein when the number of the periods counted is large, the value of the matching impedance generated by the first electrical resistance unit of the gate driver chip is correspondingly large.

6. The liquid crystal display as claimed in claim 4, wherein the number of the periods counted and the value of the matching impedance are of a linear relationship.

7. The liquid crystal display as claimed in claim 1, wherein the value of n is set to be 4-8.

8. The liquid crystal display as claimed in claim 1, wherein the first electrical resistance unit comprises a resistance variable unit.

9. A liquid crystal display, comprising:
a liquid crystal panel, which defines n first division zones in a first direction and defines n second division zones in a second direction;
a gate driver, which comprises n gate driver chips, each of the gate driver chips corresponding to one of the first division zones, the gate driver chip comprising at least a control unit and a first electrical resistance unit and a second electrical resistance unit;
a timing controller, which is arranged to supply a control signal to the liquid crystal display; and
a common voltage generator, which supplies a common voltage source, the common voltage source being fed in sequence to the n gate driver chips;
wherein the control unit receives the control signal from the timing controller and controls the first electrical resistance unit to generate a first matching impedance and the gate driver chip, in response to the common voltage source fed thereto and the first matching impedance, supplies a first common voltages from the first direction to the one of the first division zones; and the n gate driver chips respectively supply n first common voltages to the n first division zones whereby the n first common voltages are made identical through adjustments of the first matching impedances; the control unit further controls the second electrical resistance unit to generate a second matching impedance according to the control signal and the gate driver chip, in response to the second matching impedance, supplies a second common voltage from the second direction to one of the second division zones; and the n gate driver chips respectively supply n second common voltages to the n second division zones whereby the n second common voltages are made identical through adjustments of the second matching impedances, where n is an integer greater than one.

10. The liquid crystal display as claimed in claim 9, wherein the control signal is supplied from the timing controller to the control units and comprises at least a start signal and an impedance match signal, where the start signal is applicable to sequentially turn on the n gate driver chips and the impedance match signal comprises a square wave signal, each of periods of the impedance match signal corresponding to one of the gate driver chips; and the control unit of each of the gate driver chips determines and generates a value of the matching impedance according to a width of high voltage of the corresponding period of the impedance match signal, wherein a relatively large value of the matching impedance is generated for one of the gate driver chips that is relatively close to an input end of the common voltage source and a relatively small value of the matching impedance is generated for one of the gate driver chips that is relatively distant from the input end of the common voltage source.

11. The liquid crystal display as claimed in claim 10, wherein when a width of high voltage of one of the periods of the impedance match signal is relatively large, the matching impedances generated by the first electrical resistance unit and the second electrical resistance unit of the one of the gate driver chips corresponding to the period are relatively large.

12. The liquid crystal display as claimed in claim 10, wherein the gate driver chips each further comprises a counter unit and the control signal that the timing controller supplies to the control unit further comprises a clock signal; the counter unit counts the number of periods of the clock signal occurring during a width of high voltage of one of the periods of the impedance match signal and the control unit determines and generates a value of the matching impedance according to the number of the periods counted.

13. The liquid crystal display as claimed in claim 12, wherein when the number of the periods counted is large, the values of the matching impedances generated by the first electrical resistance unit and the second electrical resistance unit of the gate driver chip are correspondingly large.

14. The liquid crystal display as claimed in claim 12, wherein the number of the periods counted and the value of the matching impedance are of a linear relationship.

15. The liquid crystal display as claimed in claim 9, wherein the first direction and the second direction are perpendicular to each other; and the first direction is a short side or long side direction of the liquid crystal panel and the second direction is a long side or short side direction of the liquid crystal panel.

16. The liquid crystal display as claimed in claim 9, wherein the value of n is set to be 4-8.

17. The liquid crystal display as claimed in claim 9, wherein the first electrical resistance unit and the second electrical resistance unit each comprise a resistance variable unit.
